(19) United States
(12) Patent Application Publication
(10) Pub. No.: US 2002/0025715 A1
(43) Pub. Date: Feb. 28, 2002

(54) Power supply

(76) Inventor: Henry L. Dale, Carson City, NV (US)

Correspondence Address: Richard C. Litman, LITMAN LAW OFFICES, LTD., P.O. Box 15035, Arlington, VA, 22215, US

(21) Appl. No.: 09/942,685

(22) Filed: Aug. 31, 2001

Related U.S. Application Data
(60) Provisional application No. 60/229,846, filed on Aug. 31, 2000.

(51) Int. Cl. H01R 13/62; H01R 13/64

(52) U.S. Cl. 439/373

(57) ABSTRACT

A power supply module which has an electrical plug for plugging into an 110/220 VAC power and an electrical receptacle into which 110/220 VAC apparatuses may be plugged. When AC power is supplied to an apparatus, an electronic circuit in the power supply module detects the power use and, as a result, delivers a pulse of electrical power of a selected duration and voltage to a cable. The electrical pulse may range from less than one volt AC or DC in magnitude to the limits of the supplied AC power, and a duration from microseconds to hours. This pulse may be delivered to a home computer for monitoring of an appliance, or to another type of device that requires a predetermined level of power and duration.

### CROSS-REFERENCE TO RELATED APPLICATION

This application claims the benefit of U.S. Provisional Patent Application No. 60/229,846, filed Aug. 31, 2000.

### BACKGROUND OF THE INVENTION

1. Field of the Invention

The present invention relates to electrical power supplies. More particularly, the present invention relates to power supplies which send an electrical signal upon being activated.

2. Description of the Related Art

Garage door openers, either remote or switch operated are common. A laser sending unit is useful for assistance to the vehicle operator in positioning the vehicle in the garage. Known devices require the installation of, in the case of garage door openers, for example, a wall mounted power supply, a mechanical switch that detects the garage door being opened, or an optical switch that detects when the garage door opener light is activated, for installation of the laser sending device. This requires wiring from the power supply and switch to the laser sending unit for proper operation. This results in a cumbersome, time consuming and unsightly installation. There exists a need to supply power to a device, such as a laser sending device, which does not require an additional power supply, switches (mechanical or optical), or associated wiring. The laser sending device needs to be operated for only a limited time so it would be desirable to provide such a power supply which provides an electrical pulse equal to the time needed to operate the laser unit.

There is also a need to monitor when appliances such as a freezer, a heater, an air conditioner, outdoor lights, etc., are activated. With the advent of the smart home, it is desirable to know, via the home computer, for example, when other electrical appliances are being activated. A power supply which provides low voltage, short pulse of electric power to the computer upon activation of the appliance, would help such monitoring.

U.S. Pat. No. 5,901,056, issued May. 4, 1999 to Hung, describes a DC power supply device which can be used indoors as well as in a car to convert a city power supply or a car battery supply into the desired DC power.

U.S. Pat. No. 5,615,103, issued Mar. 25, 1997, to Steindam describes an AC power supply having a male connector and a female connector for passing AC power from a receptacle to an electric appliance plug, and having a transformer and a rectifier providing a DC current to a separate cable for supplying DC power useful as a substitute for a battery. There is no timing device disclosed for providing a pulse of DC power of desired duration.

U.S. Pat. No. 5,973,948, issued Oct. 26, 1999, to Hahn et al., describes a universal linear power supply capable of automatically supplying a regulated DC current output from a range of AC inputs.

U.S. Pat. No. 5,236,371, issued Aug. 17, 1993, to Matthis describes an electrical power supply device having a housing and at least one set of electrical prongs engageable in a wall electrical outlet. The Matthis device also contains an extension cord which may be pulled from the housing to connect a second appliance.

U.S. Pat. No. 5,777,862, issued Jul. 7, 1998, to Williams et al., describes a means of controlling switched power supplies in apparatus such as television receivers during current overload conditions by utilizing a control circuit otherwise present for switching a power supply, for example, an auxiliary power supply, on and off when changing between the run and standby modes of operation.

U.S. Pat. No. 5,914,586, issued Jun. 22, 1999, to Fujita et al., describes a power supply unit equipped with a delay circuit which provides a variable delay time so that the delay time will be longer when overdischarge is detected than when overcurrent is detected.

U.S. Pat. No. 5,793,124, issued Aug. 11, 1998, to Mitzaki, describes a power supply control system equipped with a timer mechanism, which can improve safety of, and save electric power in, a system including computers and general business machines.

None of the above inventions and patents, taken either singularly or in combination, is seen to describe the instant invention as claimed. Thus, a power supply solving the aforementioned problems is desired.

### SUMMARY OF THE INVENTION

The present invention is a power supply module which has an electrical plug for plugging into an 110/220 VAC power outlet and an electrical receptacle into which 110/220 VAC apparatuses may be plugged. When AC power is supplied to an apparatus by the power supply module, an electronic circuit in the power supply module detects the power use and, as a result, delivers a pulse of electrical power of a selected duration and voltage to a cable exiting from the power supply module. The electrical pulse may range from the order of less than one volt AC or DC in magnitude to the limits of the supplied AC power. The duration of the pulse may range from in the order of microseconds to hours. This pulse may be delivered to a home computer for monitoring of the activated apparatus, or to another type of device that requires a predetermined level of power and duration. Apparatuses intended for monitoring are household equipment such as heaters, refrigerators, and air conditioners. The power supply may also be employed to turn on security lights and a laser light unit activated for a predetermined time upon actuation of a garage door opener for assisting the driver in parking and exiting the garage

Accordingly, it is a principal object of the invention to provide a power supply unit for receiving 110/220 VAC electric power and having a receptacle for 110/220 VAC which has means for providing a pulse of electric power to a cable when said power supply unit is activated by an apparatus being plugged into said receptacle and turned on.

It is another object of the invention is to provide a pulse of power as above which is of the order of less than one volt AC or DC to the maximum AC power available.

It is a further object of the invention it to provide a pulse of power as above which has a selected duration from the order of microseconds to hours.

It is still another object of the invention to provide a power supply unit as above providing a pulse of power to monitoring equipment indicating when the unit is activated.

It is yet another object of the invention to provide a pulse of power as above which is directed to a monitoring computer.

Still another object of the invention is to provide a pulse of power as above, as desired, within the range of less than one volt AC or DC to the limit of the supplied AC power to a device which requires a predetermined level of power and duration to detect when the apparatus is activated.

Yet another object of the invention as above to provide a means of monitoring the frequency and duration of use of home utility apparatuses such as power garage door openers, refrigerators, and air conditioners.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a diagrammatic representation of a power supply unit according to the present invention.

FIG. 2 is a circuit diagram of the power supply unit of FIG. 1.

Similar reference characters denote corresponding features consistently throughout the attached drawings.

### DETAILED DESCRIPTION OF THE PREFERRED EMBODIMENTS

The present invention is a power supply module which has an electrical plug for plugging into an 110/220 VAC power and an electrical receptacle into which 110/220 VAC apparatuses may be plugged. When AC power is supplied to an apparatus by the power supply module, an electronic circuit in the power supply module detects the power use and, as a result, delivers a pulse of electrical power of a selected duration and voltage to a cable exiting from the power supply module. The electrical pulse may range from the order of less than one volt AC or DC in magnitude to the limits of the supplied AC power. The duration of the pulse may range in the order of microseconds to hours. This pulse may be delivered to a home computer for monitoring of the activated apparatus, or to another type of device that requires a predetermined level of power and duration. Apparatuses intended for monitoring are household equipment such as heaters, refrigerators, and air conditioners. The power supply may also be employed to turn on security lights and a laser light unit activated for a predetermined time upon actuation of a garage door opener for assisting the driver in parking and exiting the garage.

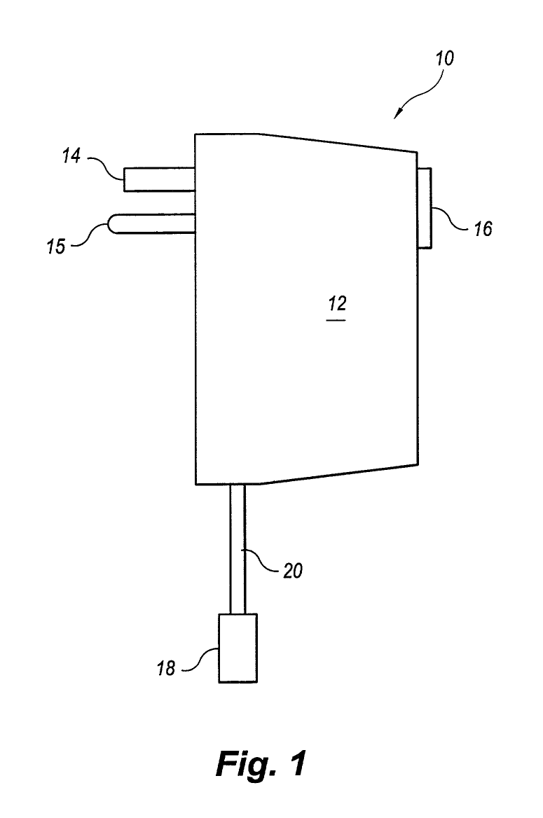

Referring to FIG. 1, there is depicted a power supply unit according to the present invention. Power supply unit 10 comprises a housing body 12, electrical plug connectors 14 with ground connector 15, and plug receptacle 16. Female connector 18 is electrically connected with housing body 12 by electrical cable 20.

The electrical plug connectors 14 and ground connector 15 of power supply unit 10 are configured to plug into a standard household 110 VAC or 220 VAC receptacle. Plug receptacle 16 allows the user to plug an apparatus into power supply unit 10. Typical apparatuses are household appliances such as garage door openers, refrigerators, air conditioners, and heating devices and security systems. The output of the receptacle 16 may be rated at the same level as the supply receptacle. Cable 20, exiting the housing 12 is capable of supplying any voltage or current, AC or DC, up to the household receptacle rating of the household current supply.

The housing 12 of the power supply 10 is preferably an ABS plastic enclosure having a standard 110 VAC NEMA plug 14,15 located in a first wall. On the opposing wall there is located a 110-VAC NEMA receptacle 16. Both plug 14, 15 and receptacle 16 have a rating of at least 15 amperes. A standard 0.100 inch female connector 18 useful for connection with a computer input cable(not shown) is connected to cable 20 exiting from housing 12.

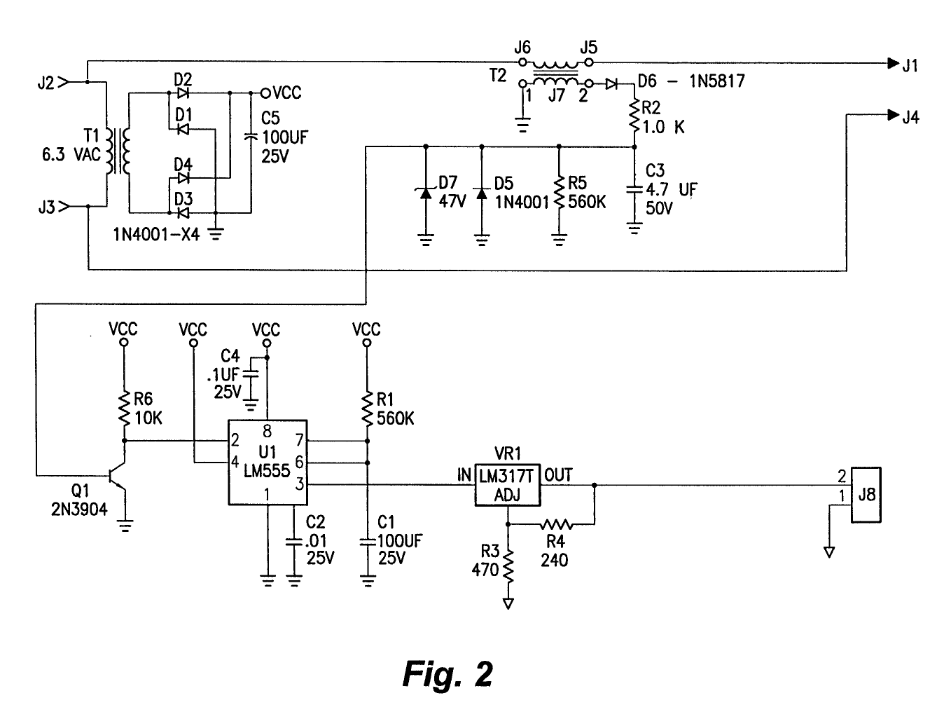

Referring to FIG. 2, circuitry connects the various electrical components to provide for the above-described functions. T1 is a 120/6.3 VAC transformer such as model ENG ELEC.ENT186. T2 is a toroid such as model Phillips No. 331XT185-3E27. J1, J2, J3, and J4 are FASTON-QUICK-FIT plug and receptacle contacts. D6 is a diode such as a model IN5817-SCHOTTKY DIODE. D1, D2, D3, D4, and D5 are rectifiers such as model IN4001-RECTIFIER. D7 is diode such as model IN5267-47 V ZENER DIODE. U1 is a timer such as model LM555CN-ND-TIMER. VR1 is a voltage regulator such as model LM317T-ND-VOLTAGE REGULATOR. Q1 is a signal transistor such as MODEL 2N3904-SIGNAL TRANSISTOR.

R1 and R5 are resistors such as, for example, a 560K OHM 1/4W resistors. R2 is a resistor such as, for example, a 1.0 K OHM 1/4 W resistor. R3 is a resistor such as, for example, a 470 OHM 1/4 W resistor. R4 is a resistor such as, for example, a 270 OHM 1/4 W resistor. R6 is a resistor such as, for example, a 10K OHM 1/4 W resistor. C1 is a capacitor such as, for example, a 100-UF 25 V capacitor. C2 is a capacitor such as, for example, a 0.01 UF 25 V capacitor. C3 is a capacitor such as, for example, a 0.1 UF 25 V capacitor. C5 is a capacitor such as, for example, a 220-UF 25 V capacitor. J7 and J8 are two-pin headers such as model MOLEX22-28-4022 2PIN HEADER.

In operation, as an example, while the power supply unit 10 is plugged into a house power receptacle, transformer T1 will step down the voltage to generate a low voltage AC source. T1 is a transformer that reduces the 115 VAC line voltages to 6.3 VAC, rated at 100 MA. This 6.3 VAC is then rectified by a full wave bridge, diodes D1, D2, D3, and D4. This rectified voltage is then filtered by a 100-UF capacitor, C5. This filtered voltage (VCC) is then supplied to all components requiring VCC.

The neutral power pin of the NEMA plug(J2) is connected to one lead of T2. T2 is a toroid core with four turns of 18 AWG solid wire on the primary side and 75 turns of 30 AWG magnet wire on the secondary side. This establishes a turns ratio of 18.75/1. The other primary lead of T2 is then connected to the neutral pin of the NEMA receptacle (J1). The line side of the NEMA plug (J3) is directly connected to the line side of the NEMA receptacle (J4).

When the demand for power by an apparatus such as a home appliance is put upon the NEMA receptacle, current flows through the primary windings of T2. This induces an energy field that is collected by T2's toroid core. The current collected by this field is than induced into the secondary windings of T2, which generates a voltage. One end of the secondary winding is connected to ground, while the other end of the secondary winding is connected to the anode of diode D6. This rectifies the trigger voltage for timer U1. This trigger voltage passes through a lowpass filter comprising resistor R2 and capacitor C3. The values of this low pass filter are selected to eliminate any false triggers created due to noise on the input AC line.

Resistor R5 keeps the base of signal transistor Q1 at the ground potential to reduce the chance of false triggering timer U1. Due to the AC nature on the primary side of toroid T2, unwanted negative voltages may develop at the base of transistor Q1, causing damage thereto. This damage is avoided by diode D5 in the circuit which clamps this voltage at an acceptable level. Due to the unknown level of current being supplied to the NEMA receptacle, an over voltage condition may develop that will again cause damage to transistor Q1.

To eliminate such damage to transistor Q1, a zener diode D7 is located in the circuit to keep the voltage at an acceptable level. This filtered trigger voltage is then applied to the base of transistor Q1 when the demand for power is present at the NEMA receptacle. The collector of transistor Q1 is connected to the trigger input of timer U1. This trigger input is pulled high to keep the trigger input at a high state until a trigger pulse is present. When timer U1 is triggered, the output of timer U1 goes into a high state for a timed duration of approximately 60 seconds. This time is set by the values of Resister R1 and Capacitor C1, and may be varied by proper selection of those values. This output passes onto the input of voltage regulator VR1.

The value of resistors R3 and R4 are selected to set the output of voltage regulator VR1 in this example to approximately 3.75 VDC. This 3.75 VDC is connected to pin 2 of 2-pin header J8 to supply the required voltage and current to the apparatus such as the laser sending module. The output voltage may also be set to supply a monitoring device, such as a home computer, the required voltage as a feedback signal that an appliance has been activated.

As an example application of the inventive power supply unit, it is plugged into a household AC outlet that is on the ceiling of a garage. The power cord of an electric garage door opener is plugged into the AC receptacle of the unit 10. The power cable 20 exiting the unit is connected to a laser sending module. When the operator activates the garage door, the unit turns on the laser sending unit. This laser light precisely guides the operator of the vehicle into the garage to an appropriate position to both left and right, and depth in the garage. In summary, the inventive power supply unit is its use as a circuit to detect when AC power is being used, then to supply a DC voltage for for a predetermined period of time to a laser sending unit, home computer, or other monitoring device.

Other applications of the inventive power supply include turning on outdoor lights when the garage door is activated, generating a pulse to inform a home computer monitoring when appliances or lighting is in use or activated. The inventive device may also be employed to monitor an electric fence, security lights, or any other device where a feedback signal that power is being consumed is desired. The feedback signal can be of a duration of microseconds to hours, depending upon the required application.

It is to be understood that the present invention is not limited to the embodiment described above, but encompasses any and all embodiments within the scope of the following claims.

I claim:

1. A power supply unit comprising:
a housing having at least first, second, and third walls;
means for receiving AC electric power into said housing;
means for providing AC electric power from said housing to an electric appliance; and
means for supplying a separate pulse of electric power from said housing to a peripheral device when AC electric power is provided from said housing to the appliance.

2. The power supply unit of claim 1, wherein said means for receiving AC electric power is a plug located on said first wall of said housing adapted for fitting into a standard household electrical receptacle providing 110/220 VAC eletric power.

3. The power supply unit of claim 1, wherein said means for providing AC electric power is a receptacle located on said second wall of said housing and opposite said first wall, the receptacle being so configured as to receive a standard household appliance plug for 110/220 VAC electric power.

4. The power supply unit of claim 1, wherein said means for supplying a separate pulse of electric power comprises a cable connected at one end with said third wall of said housing and a connector connected at an opposite end of said cable, said cable being so connected with said housing as to carry the pulse of electrical power.

5. The power supply unit of claim 1, wherein the separate electric pulse has a voltage between less than one volt AC or DC to the maximum AC power available.

6. The power supply unit of claim 1, wherein the separate electric pulse has a duration between microseconds and several hours.

7. The power supply unit of claim 1, further comprising at least two electrical conduits within said housing connecting said means for receiving and means for providing AC electric power.

8. The power supply unit of claim 1, further comprising a step down transformer connected between said means for receiving AC electric power for providing low voltage power to said means for supplying the separate pulse of electric power.

9. The power supply unit of claim 8, wherein said means for supplying said separate pulse of electric power further comprises a transformer connected between said means for receiving and said means for providing AC electric power for supplying a trigger voltage to generate the separate pulse of electric power.

10. The power supply unit of claim 9, said means for supplying the separate pulse of electric power further comprising a diode within said electrical circuit for rectifying the trigger voltage.

11. The power supply unit of claim 10, said means for supplying said separate pulse of electric power further comprising a timer integrated circuit for providing a timed pulse of electrical power in response to the trigger voltage.

12. The power supply unit of claim 11, said means for supplying the separate pulse of electric power further comprising a signal transistor between said diode and said timer, the collector of said signal transistor supplying trigger voltage to said timer.

13. The power supply unit of claim 12, said means for supplying the separate pulse of electric power further comprising a voltage regulator connected to said timer for regulating the voltage of the separate pulse of electric power.

14. The power supply unit of claim 13, said means for supplying the separate pulse of electric power further comprising a two pin header connected with said voltage regulator for supplying a timed, voltage regulated pulse of electric power to said cable and said cable connector.

15. The power supply unit of claim 1, wherein said means for supplying the separate pulse of electric power is so configured as to provide a timed, voltage regulated pulse of power of such a voltage as to operate a laser sending module connected with said cable connector, the electric appliance being a remotely activated garage door opener, and wherein the pulse is of such duration as to provide guidance to a vehicle operator for parking said vehicle in a desired position.

16. The power supply unit of claim 1, wherein said means for supplying the separate pulse of electric power is so configured as to provide a timed, voltage regulated pulse of power of such a voltage and duration as to provide a signal to a monitoring unit upon activation of a household appliance connected to said means for providing AC electric power.

17. The power supply unit of claim 16, wherein said monitoring unit is a computer.

18. The power supply unit of claim 1, wherein said means for supplying a separate pulse of electric power is so configured as to provide a timed, voltage regulated pulse of power of such a voltage and duration as to operate a security light for a desired length of time.
